(19) United States
(12) Patent Application Publication
(10) Pub. No.: US 2025/0108333 A1
(43) Pub. Date: Apr. 3, 2025

(54) Air Separation Module with a Tubesheet Support Member

(71) Applicant: Parker-Hannifin Corporation, Cleveland, OH (US)

(72) Inventors: Donald D. Stemple, Fort Worth, TX (US); Dennis P. Matteau, Lakewood, CA (US)

(21) Appl. No.: 18/754,276

(22) Filed: Jun. 26, 2024

Related U.S. Application Data
(60) Provisional application No. 63/587,493, filed on Oct. 3, 2023.
(60) Provisional application No. 63/601,779, filed on Nov. 22, 2023.

(51) Int. Cl. B01D 63/02; B01D 46/00; B01D 53/22; B01D 53/66; B01D 53/92; B64D 37/32

(52) U.S. Cl. CPC B01D 63/0231; B01D 46/0027; B01D 53/229; B01D 53/66; B01D 53/92; B64D 37/32; B01D 2053/224; B01D 2256/10; B01D 2257/104; B01D 2257/106; B01D 2258/01; B01D 2279/30; B01D 2313/04; B01D 2313/10; B01D 2313/21

(57) ABSTRACT

An example air separation module includes: a housing; a bundle of hollow fibers disposed within the housing, wherein the bundle is configured to receive inlet air and separate the inlet air into an oxygen-rich portion and a nitrogen-rich portion; an inlet tubesheet coupled to a proximal end of the bundle and configured to block respective spaces between the hollow fibers of the bundle, wherein a first side of the inlet tubesheet is configured to be subjected to the inlet air before flowing through the bundle, while a second side of the inlet tubesheet is configured to be subjected to the oxygen-rich portion having a lower pressure compared to the inlet air such that the inlet tubesheet is subjected to a pressure load; and a support member disposed downstream of the inlet tubesheet and abutting against the inlet tubesheet to support the inlet tubesheet against the pressure load.

### CROSS REFERENCE TO RELATED APPLICATION

The present application claims priority to U.S. Provisional Application No. 63/587,493 filed on Oct. 3, 2023 and U.S. Provisional Application No. 63/601,779 filed on Nov. 22, 2023, the entire contents of all of which are herein incorporated by reference as if fully set forth in this description.

### STATEMENT REGARDING RIGHTS TO INVENTION MADE UNDER FEDERALLY-SPONSORED RESEARCH AND DEVELOPMENT

This disclosure was made with government support under N00019-02-C-3002 awarded by The Department of the Navy. The government has certain rights in the invention.

### TECHNICAL FIELD

This disclosure relates to an Air Separation Module (ASM) used in aircraft fuel tank inerting systems and a method of supporting the internal structure of such ASM. More particularly, the disclosure relates to an ASM having a fiber bundle tubesheet that is supported to prevent premature delamination failures.

### BACKGROUND

Aircraft fuel tank inerting systems typically include one or more ASMs that produce inert gas to create/maintain a non-flammable environment within the aircraft fuel tank ullage. In such systems, the ASMs are fed with air that is initially drawn from the local atmosphere by the aircraft engines, then compressed, conditioned, and ultimately routed to each ASM inlet. The ASMs then separate atmospheric air into its primary components, typically nitrogen and oxygen.

Particularly, ASMs separate air into two gas streams by passing high pressure air through thousands of semipermeable hollow fibers. One airstream contains Oxygen-Enriched Air (OEA) and is exhausted overboard. The other airstream contains Nitrogen-Enriched Air (NEA) and is distributed to the aircraft fuel tanks with the intent of inerting the space above the fuel in the tanks.

An ASM typically includes an external metal shell (e.g., a housing) and an internal fiber bundle. The fiber bundle includes semipermeable hollow fibers, which are encased in two rigid epoxy tubesheets at both ends of the fiber bundle. The two tubesheets that retain the thousands of hollow fibers also provide an O-ring groove for sealing to the external metal shell. The inlet tubesheet divides the high pressure inlet air source from the low pressure OEA discharge chamber and is configured to carry the pressure load resulting from the pressure differential.

The high stresses on the tubesheet resulting from the pressure load may cause structural failure of the tubesheet in some cases. It may thus be desirable to improve the load carrying capability of the tubesheet when acting as a structural member. It is with respect to these and other considerations that the disclosure made herein is presented.

### SUMMARY

The present disclosure describes implementations that relate to an ASM with a tubesheet support member.

In a first example implementation, this disclosure describes an air separation module including: a housing; a bundle of hollow fibers disposed within the housing, wherein the bundle is configured to receive inlet air and separate the inlet air into an oxygen-rich portion and a nitrogen-rich portion; an inlet tubesheet coupled to a proximal end of the bundle and configured to block respective spaces between the hollow fibers of the bundle, wherein a first side of the inlet tubesheet is configured to be subjected to the inlet air before flowing through the bundle, while a second side of the inlet tubesheet is configured to be subjected to the oxygen-rich portion having a lower pressure compared to the inlet air such that the inlet tubesheet is subjected to a pressure load; and a support member disposed downstream of the inlet tubesheet and abutting against the inlet tubesheet to support the inlet tubesheet against the pressure load.

In a second example implementation, this disclosure describes an inerting system including the air separation module of the first example implementation.

In a third example implementation, this disclosure describes a method of assembling the air separation module of the first example implementation.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying Figures.

FIG. 1 illustrates a simplified schematic of an inerting system, according to an example implementation.

FIG. 2A illustrates a perspective view of an ASM, according to an example implementation.

FIG. 2B illustrates an enlarged view of an individual fiber of the ASM of FIG. 2A depicting a hollow fiber, according to an example implementation

FIG. 3A illustrates a schematic representation of a front view of an inlet tubesheet, according to an example implementation.

FIG. 3B illustrates a schematic representation of the load applied to the inlet tubesheet of FIG. 3A, according to an example implementation.

FIG. 4 illustrates a schematic representation of the load applied to a tubesheet when supported at its outer diameter, according to an example implementation.

FIG. 5A illustrates a partial cross-sectional view of an ASM having a support member, according to an example implementation.

FIG. 5B illustrates an enlarged view of the ASM of FIG. 5A, according to an example implementation.

FIG. 6A illustrates a front view of a support member, according to an example implementation.

FIG. 6B illustrates a side view of the support member of FIG. 6A, according to an example implementation.

FIG. 6C illustrates a cross-sectional top view of the support member of FIGS. 6A, according to an example implementation.

FIG. 7 illustrates a partial cross-sectional view of the ASM of FIGS. 6A-6C, according to an example implementation.

FIG. 8 illustrates a partial cross-sectional view of an ASM having a retaining ring that secures a support member to an inlet cap, according to an example implementation.

FIG. 9 illustrates a partial perspective view of an ASM having a support member configured to be threadedly engaged with an inlet cap, according to an example implementation.

FIG. 10 is a flowchart of a method of assembling an ASM, according to an example implementation.

### DETAILED DESCRIPTION

Disclosed herein are systems, assemblies, and methods associated with an ASM having a support member that improves the load carrying capability of a tubesheet of the ASM to prevent premature failure (e.g., delamination) of the tubesheet under pressure.

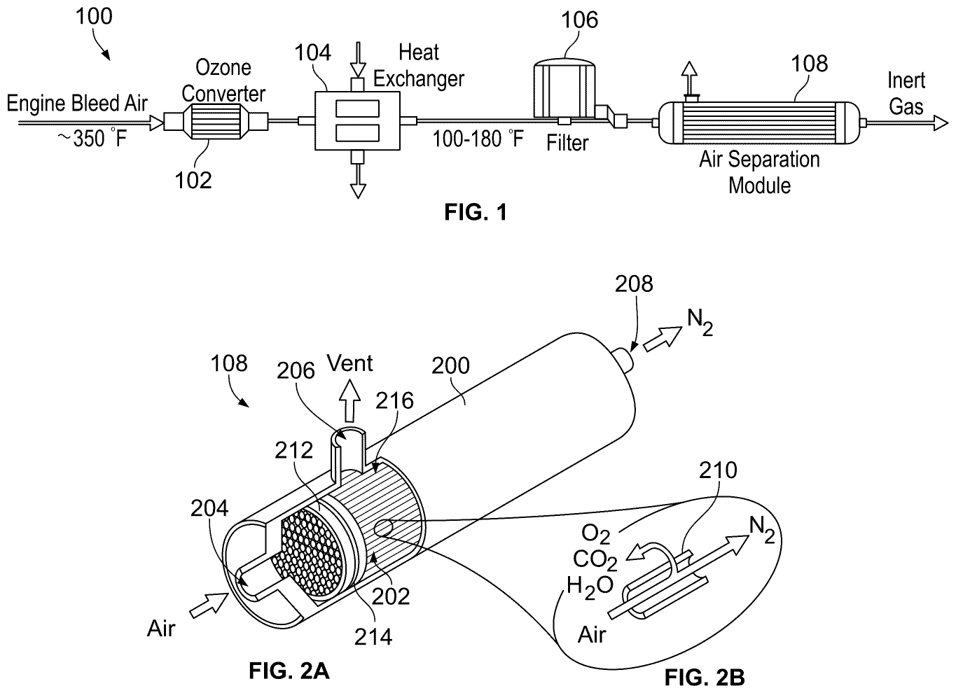

FIG. 1 illustrates a simplified schematic of an inerting system 100, according to an example implementation. The inerting system 100 includes an ozone converter 102, a heat exchanger 104, a filter 106, and an ASM 108. Although the schematic in FIG. 1 shows only a single ASM, multiple ASMs can be used in parallel depending on the size of the fuel tank and volume of ullage space to be inerted. The ASM 108 has fibers that are configured to produce inert gas, which is then delivered to the fuel tank for flammability reduction.

The source of air (e.g., compressed air) to the inerting system 100 can be the engine bleed air supply. Particularly, such air is drawn in from the local atmosphere by the aircraft engine and “bled off” one of the engine compressor stages to be used for various purposes throughout the aircraft (e.g., cabin pressurization and the inerting system 100). To ensure proper operation and service life of the ASM 108, the air being supplied to the ASM 108 is conditioned to achieve a suitable operating temperature and remove various contaminants from the air, which could potentially degrade performance and/or longevity of the ASM 108.

For example, once the bleed air enters the inerting system 100, it is directed through the ozone converter 102, which is configured to convert a significant portion of the ozone in the bleed air into oxygen to reduce ozone concentration in the air and prevent subsequent ozone-induced damage to the fibers of the ASM 108. The desired operating temperature of the bleed air entering the inerting system 100 for the type of the ozone converter 102 is typically 300° F. or higher, preferably 350° F. or higher to ensure high ozone conversion efficiency.

However, air temperatures in the 350° F.-400° F. range may be considered too high for the polymeric materials within the ASM 108. Thus, following ozone treatment in the ozone converter 102, air is cooled in the heat exchanger 104 to a temperature that is more appropriate for the ASM 108. The target temperature may vary depending on the specific ASM used. For example, a nominal inlet temperature for the ASM 108 could range from about 100° F. to 180° F.

Further, air can include particulates and aerosols that, if ingested by the ASM 108, may potentially contaminate, plug, or otherwise degrade the fibers of the ASM 108. Thus, after cooling the air to the appropriate temperature via the heat exchanger 104, the air is filtered via the filter 106 to remove the particulates and aerosols. The resulting conditioned, pressurized air stream is fed to the ASM 108.

FIG. 2A illustrates a perspective view of the ASM 108, according to an example implementation. The ASM 108 includes a housing 200 (e.g., a metallic cylindrical casing/shell). A portion of the housing 200 is removed in FIG. 2A to reveal internal components of the ASM 108.

The ASM 108 can include a bundle 202 of tens of thousands of hollow fiber membranes configured to produce inert gas, which is then delivered to the fuel tank for flammability reduction. Particularly, the ASM 108 receives air at an inlet port 204, then the bundle 202 separates the air stream into an oxygen-rich portion and a nitrogen-rich portion (which is inert). The oxygen-rich portion of the air is vented or discharged through a vent or discharge port 206 to an external environment of the aircraft, and the nitrogen-rich portion is provided via an outlet port 208 to the fuel tank. The discharge port 206 can be disposed in a transversal (e.g., perpendicular) direction relative to the inlet port 204 as depicted.

As mentioned above, the bundle 202 can include a plurality (e.g., tens of thousands) of hollow fibers. Such hollow fibers filter out oxygen through the fiber wall and allow nitrogen-rich air to pass therethrough to the outlet port 208, then to the fuel tank of an aircraft.

FIG. 2B illustrates an enlarged view of an individual fiber of the ASM 108 depicting a hollow fiber 210, according to an example implementation. Particularly, FIG. 2B shows a simplified, magnified view of the hollow fiber 210, which is one of thousands of fibers of the bundle 202. As shown, the hollow fiber 210 can be generally cylindrical and hollow. The hollow fiber 210 can be made of a polymeric material, for example.

Oxygen molecules in the air received through the inlet port 204 diffuse through the polymeric material of the hollow fiber 210 more readily than nitrogen. In other words, the bundle 202 allows preferential diffusion of oxygen therethrough. Oxygen-rich air that has permeated through the hollow fiber 210 is then discharged as waste through the discharge port 206. As such, the discharge port 206 can be referred to as a permeate gas port or waste port. On the other hand, nitrogen-rich air flows through the bore of the hollow fiber 210 to the outlet port 208 to be provided to the fuel tank.

This process is performed through all the hollow fibers of the bundle 202. This way, the ASM 108 reduces the concentration of oxygen in the air received at the inlet port 204. As an example, the ASM 108 can reduce the concentration of oxygen from 21% in the air supply to about 12% in the nitrogen-rich portion provided to the fuel tank. Such lower oxygen percentage is sufficient to render the air provided to the fuel tank inert, thereby reducing flammability of the fuel tank ullage.

To prevent air received at the inlet port 204 from flowing through respective spaces between the hollow fibers of the bundle 202, the ASM 108 includes an inlet tubesheet 212 at the proximal end of the bundle 202 and an outlet tubesheet (not shown) at the distal end thereof. In an example, the tubesheets can include epoxy tubesheets, which capture the hollow fibers to hold them in place and provide an airtight seal between the fibers. In an example, the inlet tubesheet 212 can be in the form of liquid epoxy that fills the spaces between the fibers of the bundle 202. The epoxy then hardens into the inlet tubesheet 212. The inlet tubesheet 212 thus plugs all the spaces or gaps between the fibers, thereby forcing air to flow through the bores of the hollow fibers. The inlet tubesheet 212 can additionally provide structural support for the fibers of the bundle 202 that extend through the length of the bundle 202 within the housing 200 to prevent them from moving within the housing 200.

The inlet tubesheet 212 further includes a groove formed on an exterior peripheral surface thereof. A seal 214 (e.g., an O-ring) is disposed in such groove to seal to the interior surface of the housing 200.

The inlet tubesheet 212 also provides a pressure boundary between (i) the high pressure inlet air received at the inlet port 204 and acting on a proximal or first side of the inlet tubesheet 212, and (ii) the low pressure air flow through the discharge port 206, which acts on a distal or second side of the inlet tubesheet 212. In other words, the inlet tubesheet 212 separates the high pressure inlet air received through the inlet port 204 (acting on the proximal side of the inlet tubesheet 212) from the low pressure OEA (acting on the distal side of the inlet tubesheet 212) in a discharge chamber 216, which is an annular chamber formed between an exterior surface of the bundle 202 and the interior surface of the housing 200.

As such, the inlet tubesheet 212 carries the pressure load resulting from the pressure differential between inlet air received through the inlet port 204 and discharged air (discharged through the discharge port 206). It is thus desirable for the inlet tubesheet 212 to be strong and sufficiently structurally sound to withstand the pressure differential between pressure level at the inlet port 204 and pressure level at the discharge port 206, such that the inlet tubesheet 212 does not bend or break.

As mentioned above, the inlet tubesheet 212 can be made of an epoxy. The epoxy can be molded or formed about a center rod that supports the inlet tubesheet 212. Epoxy strength degrades over time, and can degrade more quickly when exposed to high temperatures and high humidity. Further, the above-mentioned pressure loads tend to push the inlet tubesheet 212 downstream (which may cause axial translation). The resulting shear and bending loads are reacted at the center rod around which the inlet tubesheet 212 is formed and supported.

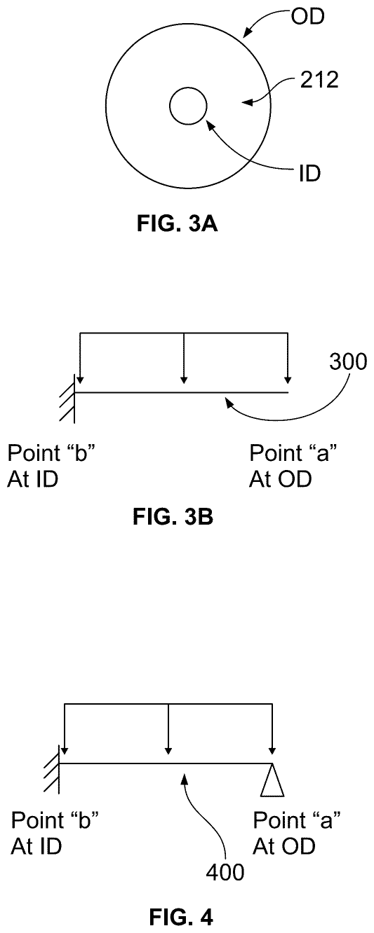

FIG. 3A illustrates a schematic representation of a front view of the inlet tubesheet 212, and FIG. 3B illustrates a schematic representation of the load applied to the inlet tubesheet 212, according to an example implementation. The inlet tubesheet 212 is fixed at its inner diameter (ID) at the center rod, and is subjected to the pressure load throughout the radial region between the inner diameter and the outer diameter (OD) of the inlet tubesheet 212.

As such, a cross section from ID to OD of the inlet tubesheet 212 can be represented schematically as a cantilever beam 300 shown in FIG. 3B. The cantilever beam 300 is fixedly supported at point “b” at the ID of the inlet tubesheet 212 and has a free (not supported) end point “a” at the OD of the cantilever beam 300. The cantilever beam 300 is subjected to the pressure load as depicted by the three downward arrows in FIG. 3B.

Once the ultimate strength of the epoxy has degraded to a level below the applied load, a crack may be generated. Such crack can propagate fully through the axial thickness of the inlet tubesheet 212. As a result, the inlet tubesheet 212 may be delaminated, typically at the highest stress area near the center rod at the ID. During high pressure conditions, the delaminated tubesheet may be pushed downstream, thereby translating axially. Eventually the shift or axial translation can be sufficient to move the seal 214 beyond its sealing surface (e.g., the seal 214 may be dislodged), resulting in a large increase in inlet flow and poor nitrogen (N2) generation, rendering the ASM 108 ineffective for inerting fuel tanks.

It may thus be desirable to support the inlet tubesheet 212 at its outer diameter. Such support may amount to supporting point “a” shown in FIG. 3B.

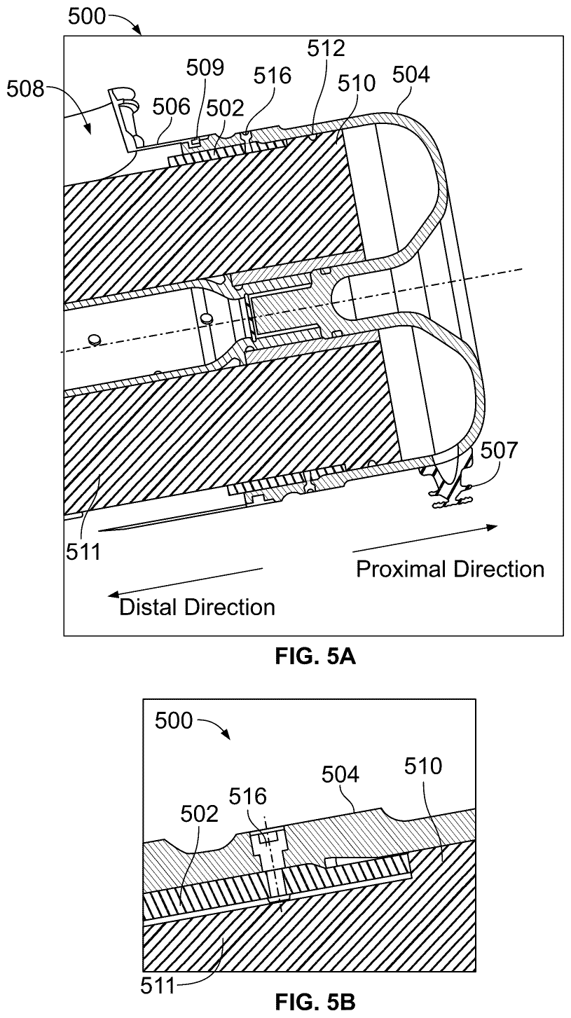

FIG. 4 illustrates a schematic representation of the load applied to a tubesheet when supported at its outer diameter, according to an example implementation. As depicted, the tubesheet is depicted as simply supported beam 400 as it is supported on both ends thereof. This configuration may render the tubesheet more structurally sound and resistant to pressure load.

FIG. 5A illustrates a partial cross-sectional view of an ASM 500 having a support member 502, and FIG. 5B illustrates an enlarged view of the ASM 500, according to an example implementation. The ASM 500 has an inlet cap 504 that is coupled to a canister or housing 506 of the ASM 500. The housing 506 can be similar to the housing 200 described above and can define an inlet port 507, a discharge port 508, and an outlet port (not shown). The inlet port 507 is disposed radially in the ASM 500, but it should be understood that an axial inlet port similar to the inlet port 204 of the ASM 108 can be used.

A seal 509 (e.g., an O-ring) can be mounted between the inlet cap 504 and the housing 506 to seal the ASM 500 against an external environment. The housing 506 can be coupled to the inlet cap 504 via fasteners (not shown), for example.

The ASM 500 further includes an inlet tubesheet 510 that can be similar to the inlet tubesheet 212 described above and is disposed at a proximal end of a bundle 511 that is similar to the bundle 202. A seal 512 (e.g., an O-ring) similar to the seal 214 can be mounted about the inlet tubesheet 510 to seal against the interior surface of the inlet cap 504.

The support member 502 is configured as a sleeve mounted around the bundle 511 and abuts against the inlet tubesheet 510. In other words, the support member 502 bears against or is secured against (or pulled snuggly to) the downstream side of the inlet tubesheet 510.

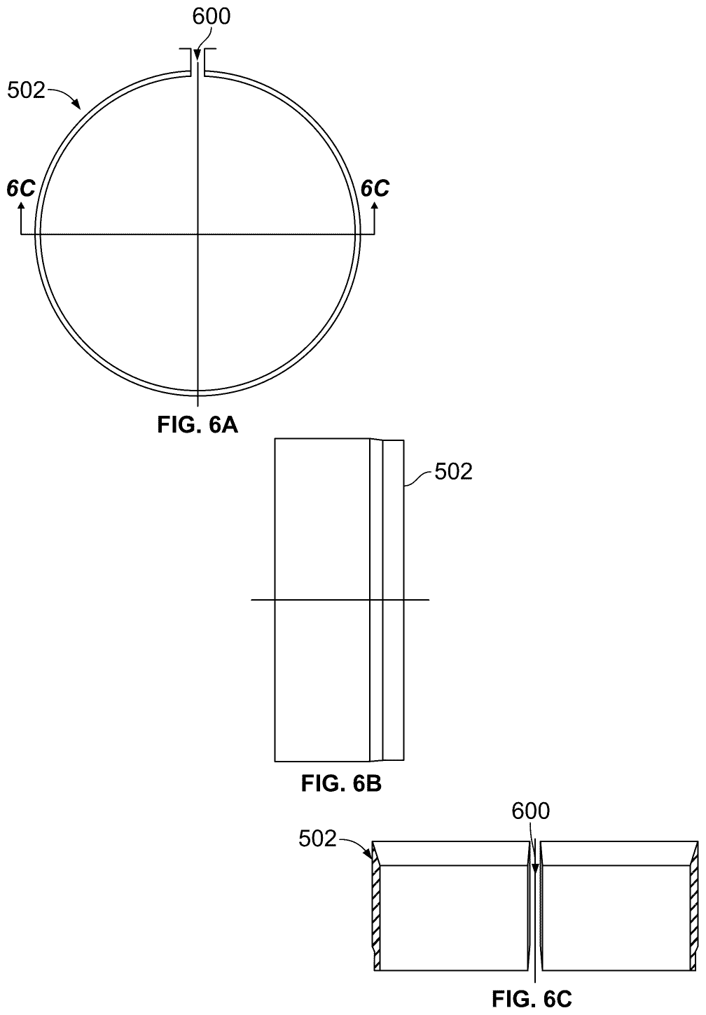

FIG. 6A illustrates a front view of the support member 502, FIG. 6B illustrates a side view of the support member 502, and FIG. 6C illustrates a cross-sectional top view of the support member 502, according to an example implementation. The cross-sectional plane of FIG. 6C is labelled in FIG. 6A.

As depicted in FIGS. 6A, 6C, in an example, the support member 502 can be configured as a split sleeve or split ring having a gap 600. The size and elasticity of the split ring/sleeve allows the support member 502 to be expanded, and then slid over the inlet tubesheet 510 in an expanded state. The support member 502 can be released once in position downstream of the inlet tubesheet 510, and then pulled against the inlet tubesheet 510.

Referring back to FIGS. 5A-5B, the support member 502 is affixed or coupled to the inlet cap 504. For example, the support member 502 can be fastened to the inlet cap 504 via fasteners (e.g., screws or pins) such as fastener 516 shown in FIGS. 5A-5B. With this configuration, the pressure load acting on the inlet tubesheet 510 is supported by the support member 502 (which abuts against the inlet tubesheet 510) and is transferred to or reacted by the inlet cap 504 to which the support member 502 is coupled.

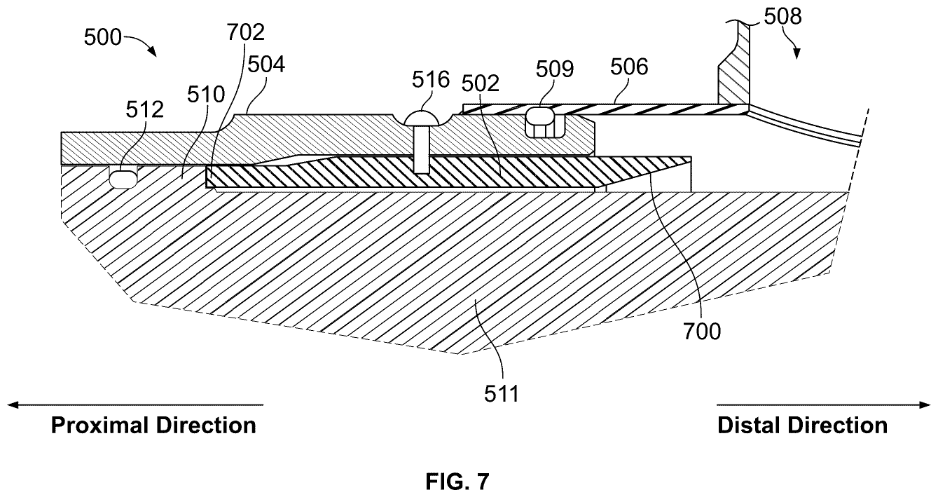

FIG. 7 illustrates a partial cross-sectional view of the ASM 500, according to an example implementation. As shown, in an example, the support member 502 can have a tapered distal end 700 to facilitate installation or insertion of the support member 502 over the inlet tubesheet 510. Particularly, during installation or assembly, the support member 502 can be oriented such that the tapered distal end 700 is disposed toward the inlet tubesheet 510. The support member 502 is then slid over the inlet tubesheet 510, facilitated by the tapering of the tapered distal end 700.

The support member 502 is then released around the bundle 511 downstream of the inlet tubesheet 510. A proximal end 702 of the support member 502 is a straight or squared end that is then abutted against the inlet tubesheet 510 to react the load at the outer diameter of the inlet tubesheet 510.

Reference to “distal” and “proximal” herein is not intended to imply a specific orientation of components of the ASM 500 relative to any surrounding environment. Instead, these directional terms are intended to facilitate a description of the interrelationship between the several components of the ASM 500 and their function.

With the implementation shown in FIGS. 5A-7, the support member 502, which is a small light weight member, supports the outer or peripheral end (e.g., at the outside diameter) of the inlet tubesheet 510. The support member 502 can be installed after the epoxy tubesheets are formed, and is configured to react or transfer the pressure load to which the inlet tubesheet 510 is subjected to the inlet cap 504. Otherwise, the support member 502 does not affect the performance of the ASM 500, and has negligible impact to the size or envelope of the ASM 500.

Table 1 below illustrates the improvement resulting from using the support member 502. As indicated by Table 1, when using the baseline configuration (cantilever configuration of FIG. 3B without the support member 502), the inlet tubesheet 510 experiences a bending stress σ of 444 pound per square inch (psi) and a shear stress of 253 psi when subjected to 60 psi gauge pressure. With the support member 502 (both ends of the inlet tubesheet 510 being supported as in the configuration of FIG. 4), the load is distributed more evenly. As a result, the bending stress is reduced to 107 (approximately four times less) and the shear stress is reduced to 148 when subjected to 60 psi gauge pressure.

TABLE 1
Stress reduction when using the support member 502

| | ID | OD | σ bend | Shear | MS | MS |
|---|---|---|---|---|---|---|
| Configuration | Support | Support | (psi) | (psi) | bend | shear |
| Baseline | Clamped | Free | 444 | 253 | −0.07 | −0.06 |
| Improved | Clamped | Simple | 107 | 148 | 2.88 | 0.61 |
| configuration | | support | | | | |

Further the Margin of Safety (MS) for the baseline configuration has negative values in both bend and shear stresses, which indicates that failure or degradation of the inlet tubesheet is likely to occur. On the other hand, the MS for both bend and shear stresses for the improved configuration of FIGS. 5A-7 including the support member 502 has positive values, indicating a much improved structural integrity of the assembly.

Several variations can be implemented to the configuration shown in FIGS. 5A-7, while maintaining the principle of supporting the inlet tubesheet 510 in a manner that reduces the stress to which it is exposed.

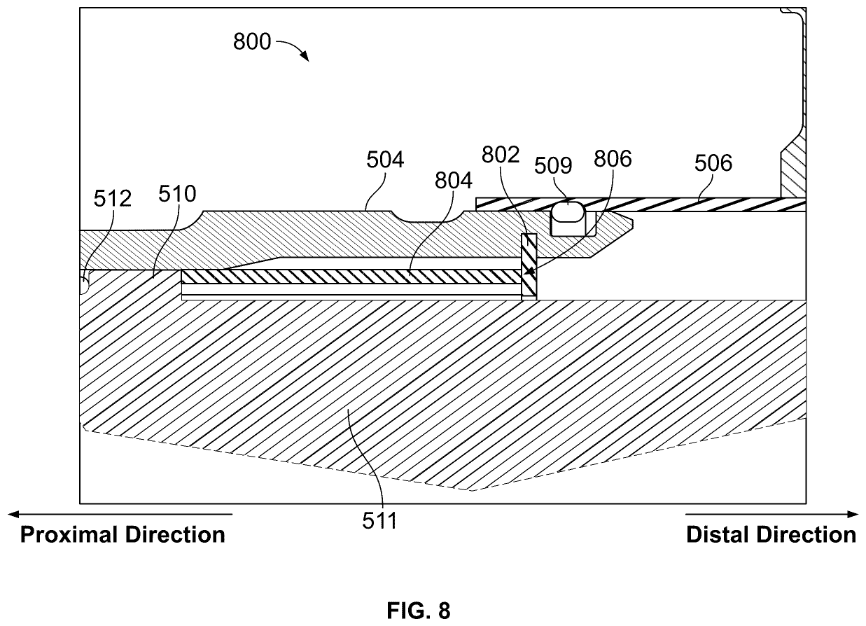

FIG. 8 illustrates a partial cross-sectional view of an ASM 800 having a retaining ring 802 that secures a support member 804 to the inlet cap 504, according to an example implementation. The retaining ring 802 is used instead of the fasteners (e.g., the fastener 516) to couple the support member 804 (e.g., a sleeve) to the inlet cap 504. The retaining ring 802 can be a C-clip ring or other similar types of retaining rings, for example.

The retaining ring 802 is mounted around the bundle 511 and is secured to the inlet cap 504 (e.g., in a groove formed in the inlet cap 504) as depicted in FIG. 8. The proximal end of the support member 804 bears against the inlet tubesheet 510 similar to the support member 502, while a distal end of the support member 804 bears against or interfaces with the retaining ring 802. The support member 804 is thus interposed and secured axially between the inlet tubesheet 510 and retaining ring 802. In an example, one or more shims 806 can be used to ensure snug contact between the support member 804 and the inlet tubesheet 510.

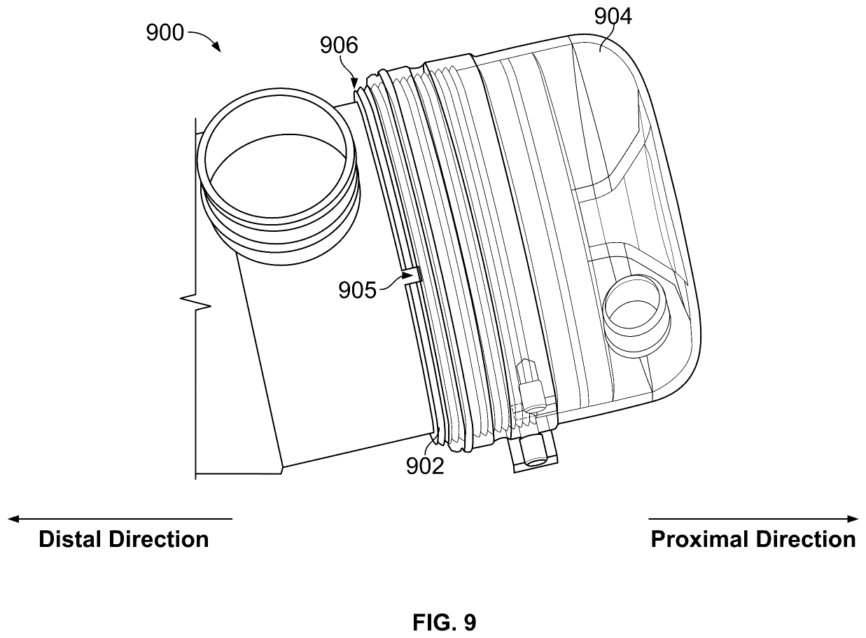

FIG. 9 illustrates a partial perspective view of an ASM 900 having a support member 902 configured to be threadedly engaged with an inlet cap 904, according to an example implementation. The support member 902 can be configured to be a split ring or sleeve having a gap 905 similar to the support member 502 to allow the support member 902 to be expanded to slide over the inlet tubesheet then released once in position.

However, rather than being coupled to the inlet cap 904 via fasteners or retained via a retaining ring, the support member 902 can have external threads 906 that engage with corresponding internal threads of the inlet cap 904 at a threaded interface. This way, the inlet cap 904 and the support member 902 are screwed together, drawing the support member 902 to be snug against the inlet tubesheet.

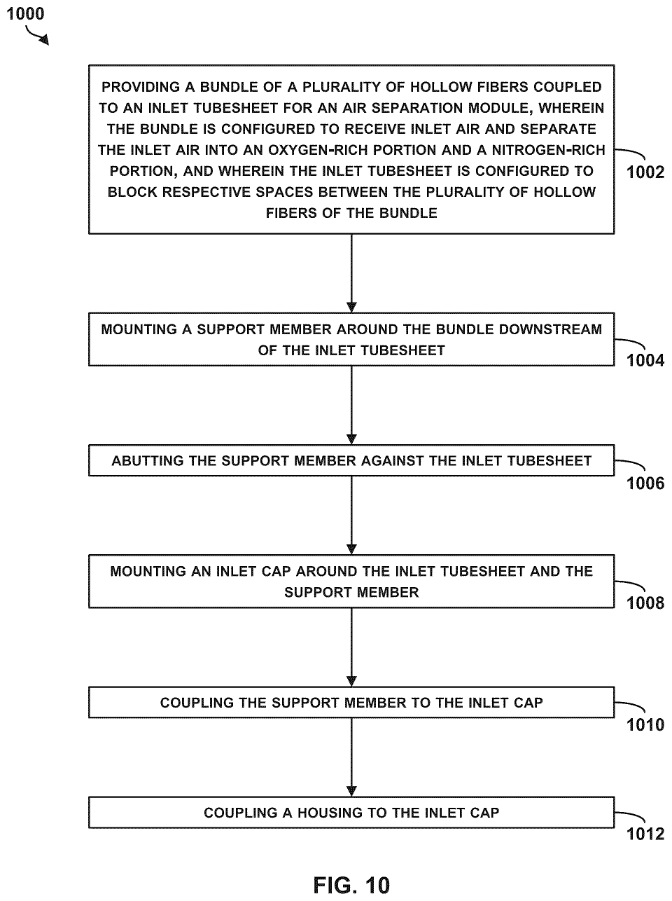

FIG. 10 is a flowchart of a method 1000 of assembling an ASM, according to an example implementation. The method 1000 can be used to assembly any of the ASMs (e.g., the ASM 500, 800, 900) described above, for example.

The method 1000 may include one or more operations, functions, or actions as illustrated by one or more of blocks 1002-1012. Although the blocks are illustrated in a sequential order, these blocks may also be performed in parallel, and/or in a different order than those described herein. Also, the various blocks may be combined into fewer blocks, divided into additional blocks, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 1002, the method 1000 includes providing a bundle (e.g., the bundle 511) of a plurality of hollow fibers coupled to an inlet tubesheet (e.g., the inlet tubesheet 510) for an air separation module (e.g., the ASM 500, 800, 900), wherein the bundle is configured to receive inlet air and separate the inlet air into an oxygen-rich portion and a nitrogen-rich portion, and wherein the inlet tubesheet is configured to block respective spaces between the plurality of hollow fibers of the bundle. The term “providing” as used herein, and for example with regard to the bundle and the inlet tubesheet or other components, includes any action to make the assembly of the bundle and the inlet tubesheet or any other component available for use, such as bringing the assembly of the bundle and the inlet tubesheet to an apparatus or to a work environment for further processing (e.g., mounting other components, further processing/machining, etc.).

At block 1004, the method 1000 includes mounting a support member (e.g., the support member 502, 804, 902) around the bundle downstream of the inlet tubesheet.

At block 1006, the method 1000 includes abutting the support member against the inlet tubesheet.

At block 1008, the method 1000 includes mounting an inlet cap (e.g., the inlet cap 504, 904) around the inlet tubesheet and the support member.

At block 1010, the method 1000 includes coupling the support member to the inlet cap. The support member can be coupled to the inlet cap in various ways such as fasteners or threaded engagement as described above.

At block 1012, the method 1000 includes coupling a housing (e.g., the housing 506) to the inlet cap.

The method 1000 can further include any of the other steps or operations described throughout herein.

For example, as described above, the support member 502, 902 can be configured as a split ring having the gap 600, 905. In this example, mounting the support member around the bundle downstream of the inlet tube sheet can include: expanding the support member; sliding the support member in an expanded state over the inlet tubesheet; and releasing the support member once in position downstream of the inlet tubesheet.

In an example, the support member can have a proximal end (e.g., the proximal end 702) that is straight and the tapered distal end 700. In this example, mounting the support member around the bundle downstream of the inlet tubesheet can include: orienting the support member such that the tapered distal end is disposed toward the inlet tubesheet; sliding the support member over the inlet tubesheet; and releasing the support member once in position downstream of the inlet tubesheet, wherein abutting the support member against the inlet tubesheet comprises abutting the proximal end of the support member against a distal side of the inlet tubesheet.

In an example, the method 1000 can include mounting the retaining ring 802 around the bundle 511 such that the retaining ring 802 is coupled to the inlet cap 504. In this example, coupling the support member 804 to the inlet cap comprises securing the support member 804 between the inlet tubesheet 510 and the retaining ring 802.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to those skilled in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiments (EEEs) listed below.

EEE 1 is an air separation module comprising: a housing; a bundle of a plurality of hollow fibers disposed within the housing, wherein the bundle is configured to receive inlet air and separate the inlet air into an oxygen-rich portion and a nitrogen-rich portion; an inlet tubesheet coupled to a proximal end of the bundle and configured to block respective spaces between the plurality of hollow fibers of the bundle, thereby forcing the inlet air to flow through the plurality of hollow fibers, wherein a first side of the inlet tubesheet is configured to be subjected to the inlet air before flowing through the bundle, while a second side of the inlet tubesheet is configured to be subjected to the oxygen-rich portion having a lower pressure compared to the inlet air such that the inlet tubesheet is subjected to a pressure load; and a support member disposed downstream of the inlet tubesheet and abutting against the inlet tubesheet to support the inlet tubesheet against the pressure load.

EEE 2 is the air separation module of EEE 1, wherein the support member is configured as a split ring having a gap, allowing the support member to be expanded to slide over the inlet tubesheet, then released once in position downstream of the inlet tubesheet.

EEE 3 is the air separation module of any of EEEs 1-2, further comprising: an inlet cap coupled to the housing, wherein the support member is coupled to the inlet cap such that the pressure load acting on the inlet tubesheet is transferred to the inlet cap via the support member.

EEE 4 is the air separation module of EEE 3, wherein the support member is coupled to the inlet cap via one or more fasteners.

EEE 5 is the air separation module of any of EEEs 3-4, wherein the support member is threadedly engaged with the inlet cap.

EEE 6 is the air separation module of any of EEEs 1-5, wherein the support member has a respective proximal end that is straight and abutting against a distal side of the inlet tubesheet, and wherein the support member has a tapered distal end to facilitate installation of the support member over the inlet tubesheet.

EEE 7 is the air separation module of any of EEEs 1-6, further comprising: an inlet cap coupled to the housing; and a retaining ring coupled to the inlet cap, wherein the support member is interposed between the inlet tubesheet and the retaining ring such that the pressure load acting on the inlet tubesheet is transferred to the inlet cap via the support member and the retaining ring.

EEE 8 is the air separation module of any of EEEs 1-7, further comprising: a seal disposed in a groove formed in the inlet tubesheet, wherein the seal is configured to seal against the housing to prevent the inlet air from flowing between the housing and the inlet tubesheet such that the inlet air is forced to flow through the bundle.

EEE 9 a method of assembling the air separation module of any of EEEs 1-8. For example, EEE 9 is a method comprising: providing a bundle of a plurality of hollow fibers coupled to an inlet tubesheet for an air separation module, wherein the bundle is configured to receive inlet air and separate the inlet air into an oxygen-rich portion and a nitrogen-rich portion, and wherein the inlet tubesheet is configured to block respective spaces between the plurality of hollow fibers of the bundle; mounting a support member around the bundle downstream of the inlet tubesheet; abutting the support member against the inlet tubesheet; mounting an inlet cap around the inlet tubesheet and the support member; coupling the support member to the inlet cap; and coupling a housing to the inlet cap.

EEE 10 is the method of EEE 9, wherein the support member is configured as a split ring having a gap, and wherein mounting the support member around the bundle downstream of the inlet tubesheet comprises: expanding the support member; sliding the support member in an expanded state over the inlet tubesheet; and releasing the support member once in position downstream of the inlet tubesheet.

EEE 11 is the method of any of EEEs 9-10, wherein coupling the support member to the inlet cap comprises: coupling the support member to the inlet cap via one or more fasteners.

EEE 12 is the method of any of EEEs 9-11, wherein coupling the support member to the inlet cap comprises: threadedly engaging the support member with the inlet cap.

EEE 13 is the method of any of EEEs 9-12, wherein the support member has a proximal end that is straight and has a tapered distal end, and wherein mounting the support member around the bundle downstream of the inlet tubesheet comprises: orienting the support member such that the tapered distal end is disposed toward the inlet tubesheet; sliding the support member over the inlet tubesheet; and releasing the support member once in position downstream of the inlet tubesheet, wherein abutting the support member against the inlet tubesheet comprises abutting the proximal end of the support member against a distal side of the inlet tubesheet.

EEE 14 is the method of any of EEEs 9-13, further comprising: mounting a retaining ring around the bundle such that the retaining ring is coupled to the inlet cap, wherein coupling the support member to the inlet cap comprises securing the support member between the inlet tubesheet and the retaining ring.

EEE 15 is the method of any of EEEs 9-14, further comprising: mounting a seal in a groove formed in the inlet tubesheet.

EEE 16 is an inerting system comprising: an ozone converter configured to receive air bled from an engine of an aircraft and reduce ozone concentration in the air; a heat exchanger disposed downstream of the ozone converter and configured to cool the air discharged from the ozone converter; a filter disposed downstream of the heat exchanger and configured to remove particulates and aerosols from the air; and the air separation module of any of EEEs 1-8 or the air separation module assembled by the method of any of EEEs 9-15 disposed downstream from the filter. For example, the air separation module comprises: a housing, a bundle of a plurality of hollow fibers disposed within the housing, wherein the bundle is configured to receive the air discharged from the filter and separate the air into an oxygen-rich portion and a nitrogen-rich portion, an inlet tubesheet coupled to a proximal end of the bundle and configured to block respective spaces between the plurality of hollow fibers of the bundle, thereby forcing the air to flow through the plurality of hollow fibers, wherein a first side of the inlet tubesheet is configured to be subjected to the air before flowing through the bundle, while a second side of the inlet tubesheet is configured to be subjected to the oxygen-rich portion having a lower pressure compared to the air received from the filter such that the inlet tubesheet is subjected to a pressure load, and a support member disposed downstream of the inlet tubesheet and abutting against the inlet tubesheet to support the inlet tubesheet against the pressure load.

EEE 17 is the inerting system of EEE 16, wherein the support member is configured as a split ring having a gap, allowing the support member to be expanded to slide over the inlet tubesheet, then released once in position downstream of the inlet tubesheet.

EEE 18 is the inerting system of any of EEEs 16-17, further comprising: an inlet cap coupled to the housing, wherein the support member is coupled to the inlet cap such that the pressure load acting on the inlet tubesheet is transferred to the inlet cap via the support member, wherein the support member is coupled to the inlet cap via one or more fasteners or is threadedly engaged with the inlet cap.

EEE 19 is the inerting system of any of EEEs 16-18, wherein the support member has a respective proximal end that is straight and abutting against the inlet tubesheet, and wherein the support member has a tapered distal end to facilitate installation of the support member above the inlet tubesheet.

EEE 20 is the inerting system of any of EEEs 16-19, further comprising: an inlet cap coupled to the housing; and a retaining ring coupled to the inlet cap, wherein the support member is interposed between the inlet tubesheet and the retaining ring such that the pressure load acting on the inlet tubesheet is transferred to the inlet cap via the support member and the retaining ring.

What is claimed is:

1. An air separation module comprising:
a housing;
a bundle of a plurality of hollow fibers disposed within the housing, wherein the bundle is configured to receive inlet air and separate the inlet air into an oxygen-rich portion and a nitrogen-rich portion;
an inlet tubesheet coupled to a proximal end of the bundle and configured to block respective spaces between the plurality of hollow fibers of the bundle, thereby forcing the inlet air to flow through the plurality of hollow fibers, wherein a first side of the inlet tubesheet is configured to be subjected to the inlet air before flowing through the bundle, while a second side of the inlet tubesheet is configured to be subjected to the oxygen-rich portion having a lower pressure compared to the inlet air such that the inlet tubesheet is subjected to a pressure load; and
a support member disposed downstream of the inlet tubesheet and abutting against the inlet tubesheet to support the inlet tubesheet against the pressure load.

2. The air separation module of claim 1, wherein the support member is configured as a split ring having a gap, allowing the support member to be expanded to slide over the inlet tubesheet, then released once in position downstream of the inlet tubesheet.

3. The air separation module of claim 1, further comprising:
an inlet cap coupled to the housing, wherein the support member is coupled to the inlet cap such that the pressure load acting on the inlet tubesheet is transferred to the inlet cap via the support member.

4. The air separation module of claim 3, wherein the support member is coupled to the inlet cap via one or more fasteners.

5. The air separation module of claim 3, wherein the support member is threadedly engaged with the inlet cap.

6. The air separation module of claim 1, wherein the support member has a respective proximal end that is straight and abutting against a distal side of the inlet tubesheet, and wherein the support member has a tapered distal end to facilitate installation of the support member over the inlet tubesheet.

7. The air separation module of claim 1, further comprising:
an inlet cap coupled to the housing; and
a retaining ring coupled to the inlet cap, wherein the support member is interposed between the inlet tubesheet and the retaining ring such that the pressure load acting on the inlet tubesheet is transferred to the inlet cap via the support member and the retaining ring.

8. The air separation module of claim 1, further comprising:
a seal disposed in a groove formed in the inlet tubesheet, wherein the seal is configured to seal against the housing to prevent the inlet air from flowing between the housing and the inlet tubesheet such that the inlet air is forced to flow through the bundle.

9. A method comprising:
providing a bundle of a plurality of hollow fibers coupled to an inlet tubesheet for an air separation module, wherein the bundle is configured to receive inlet air and separate the inlet air into an oxygen-rich portion and a nitrogen-rich portion, and wherein the inlet tubesheet is configured to block respective spaces between the plurality of hollow fibers of the bundle;
mounting a support member around the bundle downstream of the inlet tubesheet;
abutting the support member against the inlet tubesheet;
mounting an inlet cap around the inlet tubesheet and the support member;
coupling the support member to the inlet cap; and
coupling a housing to the inlet cap.

10. The method of claim 9, wherein the support member is configured as a split ring having a gap, and wherein mounting the support member around the bundle downstream of the inlet tubesheet comprises:
expanding the support member;
sliding the support member in an expanded state over the inlet tubesheet; and
releasing the support member once in position downstream of the inlet tubesheet.

11. The method of claim 9, wherein coupling the support member to the inlet cap comprises:
coupling the support member to the inlet cap via one or more fasteners.

12. The method of claim 9, wherein coupling the support member to the inlet cap comprises:
threadedly engaging the support member with the inlet cap.

13. The method of claim 9, wherein the support member has a proximal end that is straight and has a tapered distal end, and wherein mounting the support member around the bundle downstream of the inlet tubesheet comprises:
orienting the support member such that the tapered distal end is disposed toward the inlet tubesheet;
sliding the support member over the inlet tubesheet; and
releasing the support member once in position downstream of the inlet tubesheet, wherein abutting the support member against the inlet tubesheet comprises abutting the proximal end of the support member against a distal side the inlet tubesheet.

14. The method of claim 9, further comprising:
mounting a retaining ring around the bundle such that the retaining ring is coupled to the inlet cap, wherein coupling the support member to the inlet cap comprises securing the support member between the inlet tubesheet and the retaining ring.

15. The method of claim 9, further comprising:
mounting a seal in a groove formed in the inlet tubesheet.

16. An inerting system comprising:
an ozone converter configured to receive air bled from an engine of an aircraft and reduce ozone concentration in the air;
a heat exchanger disposed downstream of the ozone converter and configured to cool the air discharged from the ozone converter;
a filter disposed downstream of the heat exchanger and configured to remove particulates and aerosols from the air; and
an air separation module disposed downstream from the filter, wherein the air separation module comprises:
a housing,
a bundle of a plurality of hollow fibers disposed within the housing, wherein the bundle is configured to receive the air discharged from the filter and separate the air into an oxygen-rich portion and a nitrogen-rich portion,
an inlet tubesheet coupled to a proximal end of the bundle and configured to block respective spaces between the plurality of hollow fibers of the bundle, thereby forcing the air to flow through the plurality of hollow fibers, wherein a first side of the inlet tubesheet is configured to be subjected to the air before flowing through the bundle, while a second side of the inlet tubesheet is configured to be subjected to the oxygen-rich portion having a lower pressure compared to the air received from the filter such that the inlet tubesheet is subjected to a pressure load, and
a support member disposed downstream of the inlet tubesheet and abutting against the inlet tubesheet to support the inlet tubesheet against the pressure load.

17. The inerting system of claim 16, wherein the support member is configured as a split ring having a gap, allowing the support member to be expanded to slide over the inlet tubesheet, then released once in position downstream of the inlet tubesheet.

18. The inerting system of claim 16, further comprising:
an inlet cap coupled to the housing, wherein the support member is coupled to the inlet cap such that the pressure load acting on the inlet tubesheet is transferred to the inlet cap via the support member, wherein the support member is coupled to the inlet cap via one or more fasteners or is threadedly engaged with the inlet cap.

19. The inerting system of claim 16, wherein the support member has a respective proximal end that is straight and abutting against the inlet tubesheet, and wherein the support member has a tapered distal end to facilitate installation of the support member above the inlet tubesheet.

20. The inerting system of claim 16, further comprising:
an inlet cap coupled to the housing; and
a retaining ring coupled to the inlet cap, wherein the support member is interposed between the inlet tubesheet and the retaining ring such that the pressure load acting on the inlet tubesheet is transferred to the inlet cap via the support member and the retaining ring.
